(19) United States
(12) Patent Application Publication
(10) Pub. No.: US 2017/0329952 A1
(43) Pub. Date: Nov. 16, 2017

(54) Casual Digital Ink Applications

(71) Applicant: Microsoft Technology Licensing, LLC, Redmond, WA (US)

(72) Inventors: Katsumi Take, Bothell, WA (US); Gregg Robert Wygonik, Duvall, WA (US); Robert John Connon, Kirkland, WA (US)

(21) Appl. No.: 15/154,092

(22) Filed: May 13, 2016

(51) Int. Cl. G06F 21/36; G06T 11/20; G06F 3/0354

(52) U.S. Cl. CPC G06F 21/36; G06F 3/03545; G06T 11/203

(57) ABSTRACT

Providing casual digital ink experiences on an active pen capable computing device. A method includes detecting an active pen interaction with a screen of the computing device. The computing device comprises a locked lock screen requiring authentication to unlock the lock screen. As a result of detecting the active pen interaction with the screen of the computing device, the method further includes launching a casual digital ink experience without requiring authentication to the computing device, such that the casual digital ink experience is launched without unlocking the lock screen.

### BACKGROUND

### Background and Relevant Art

Computers and computing systems have affected nearly every aspect of modern living. Computers are generally involved in work, recreation, healthcare, transportation, entertainment, household management, etc.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer.

Often, users have personal computing devices such as tablets and cellular telephones. Typically, such a computing system will have personal data stored on the computing system and accessible by a user authenticating to the computing system to unlock a lock screen allowing the user to interact with various applications.

A user may wish to allow others to borrow their handheld computing system for various casual uses. For example, consider the case where a parent may wish to allow a child to use a personal computing device owned by the parent and having the parents account and user information stored on the personal computing device. However, the users may not wish for those to whom the computing system that is loaned to be able to access personal data on the computing system.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced on an active pen capable computing device. The method includes acts for providing casual digital ink experiences on the active pen capable computing device. The method includes detecting an active pen interaction with a screen of the computing device. The computing device comprises a locked lock screen requiring authentication to unlock the lock screen. As a result of detecting the active pen interaction with the screen of the computing device, the method further includes launching a casual digital ink experience without requiring authentication to the computing device, such that the casual digital ink experience is launched without unlocking the lock screen.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an active pen interacting with a screen of a computing device;

FIG. 2 illustrates an example of a lock screen and a set of casual interactions on the screen of a computing device;

FIG. 3 illustrates a distance measurement from an active pen to the screen of a computing device;

FIG. 4A illustrates an active pen creating a form on the screen of a computing device;

FIG. 4B illustrates an active pen creating a form on the screen of a computing device;

FIG. 4C illustrates an active pen creating a form on the screen of a computing device;

FIG. 4D illustrates an active pen creating a form on the screen of a computing device;

FIG. 4E illustrates an active pen creating a form on the screen of a computing device;

FIG. 4F illustrates an active pen creating a form on the screen of a computing device;

FIG. 5 illustrates functionality for erasing content in a casual experience on a computing device;

FIG. 6 illustrates a method of providing casual experiences on a computing device.

### DETAILED DESCRIPTION

Some embodiments described herein may allow a user to interact with a personal computing device using an active pen and digital ink without needing to authenticate to the computing system even when the computing system would ordinarily require a user to authenticate to the computing system to access other applications and services at the computing system. In particular, some embodiments may allow casual digital ink experiences “above the lock screen”. As used herein, an active pen is a pen which includes a particular set of electronics that allows the active pen to interact with a computing system actively by transmitting and/or receiving electronic signals from a computing device. An active pen can be differentiated from passive devices, such as a stylus, which includes no electronics for interacting with a computing system, but rather simply relies on electronics of the computing system itself to detect interaction of the stylus with the computing system.

Embodiments can host series of casual interactions that utilize an active pen. In some embodiments, the interactions are accessible using an active pen above a lock (such as a lock screen) by bringing the active pen close to the device surface. For example, some devices are configured to detect and react to active pens that are around 5 mm above a screen of the device. Such casual digital ink experiences may include one or more digital adult coloring books, hangman, tic-tac-toe, Sudoku, crossword puzzles, connecting the dots, etc.

Many computer systems, and especially tablet and handheld devices, allow users to interact with a computing system using an active pen to create so-called digital ink. Digital ink can be used to digitally represent handwriting in its natural form on a screen. This can be accomplished by an active pen being proximate the screen and having a digitizer configured to detect the movement of the active pen proximate the screen and to record the movement on a screen such that the screen appears as if the user has written with liquid ink on a writing surface.

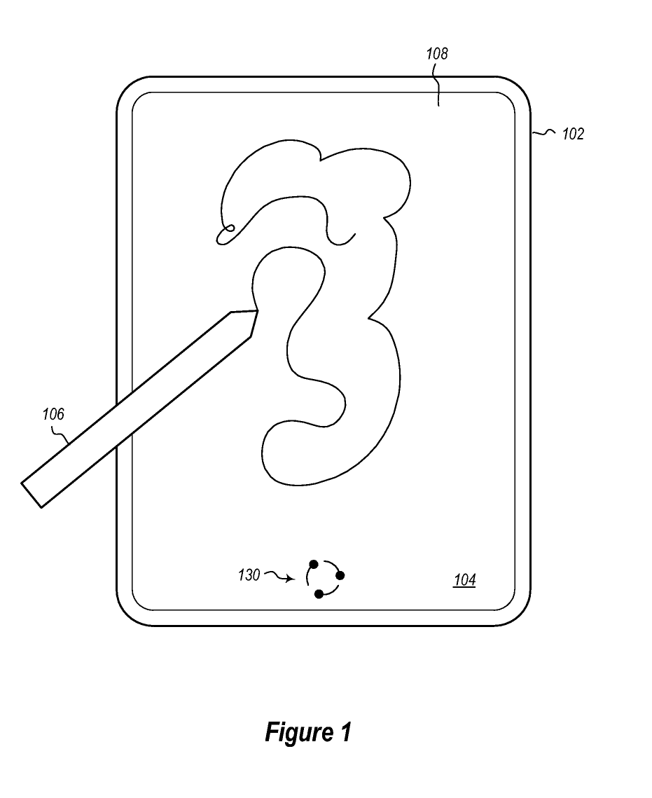

Referring now to FIG. 1, an example is illustrated. FIG. 1 illustrates a personal computing device 102. The personal computing device 102 includes a screen 104. The screen 104 includes various pieces of digitizing hardware that allow a user to interact in a pen and/or touch centric way. For example, FIG. 1 illustrates an active pen 106. The active pen can be brought proximate, including touching, the screen 104.

Embodiments may be implemented such that the personal computing device 102 detects interaction of the active pen 106 with the screen 104. When this interaction is detected, a casual digital ink experience may be launched. In some embodiments, this occurs automatically as a result of the personal computing device 102 implementing a lock screen which prevents access generally to the personal computing device 102 until the user can authenticate to the lock screen.

If the personal computing device 102 is locked by a lock screen, and the user interacts with the screen 101 with the active pen 106, in some embodiments a casual digital ink experience is automatically launched which does not require a user to authenticate to the personal computing device 102 to use the casual digital ink experience. In particular, the personal computing device 102 can maintain secrecy of user data for user accounts on the personal computing device 102, while still allowing other users to use the casual digital ink experience without needing to authenticate to the personal computing device 102 and without being able to access personal user data contained in user accounts on the personal computing device 102.

For example the personal computing device 102 may be obtained by a user other than a user who has user accounts on the personal computing device 102 (although the casual digital ink experience may also be experienced by users who have accounts on the personal computing device 102). The user can use the active pen 106 to interact with the screen 104. The casual digital ink experience 108 may be launched. This would allow the user to interact with the casual digital ink experience 108 without needing to authenticate to the personal computing device 102. Such casual digital ink experiences may include, for example, drawing applications, coloring book applications, tick-tack-toe applications, crossword applications, hangman applications, dot interactions applications, Sudoku applications, or other ink centric applications.

In some embodiments, the casual digital ink experience can be persisted from user session to user session. For example, after a user interacts with the casual digital ink experience 108, the user could stop using the personal computing device 102 and place it in a location accessible by other users. If the user or another user again interacts with a personal computing device 102 by causing the active pen 106 to interact with the screen 104 while the personal computing device 102 is locked behind a lock screen, embodiments may display the casual digital ink experience 108 in the same state as it was when the original user stopped using the personal computing device 102. Thus, the original user could resume whatever activities were being performed on the casual digital ink experience 108. Alternatively a different user could take up where the first user left off in the digital ink experience 108. Note that the casual digital ink experience 108 is not tied to any particular user, but rather is available communally as there is no need to authenticate to the personal computing device 102.

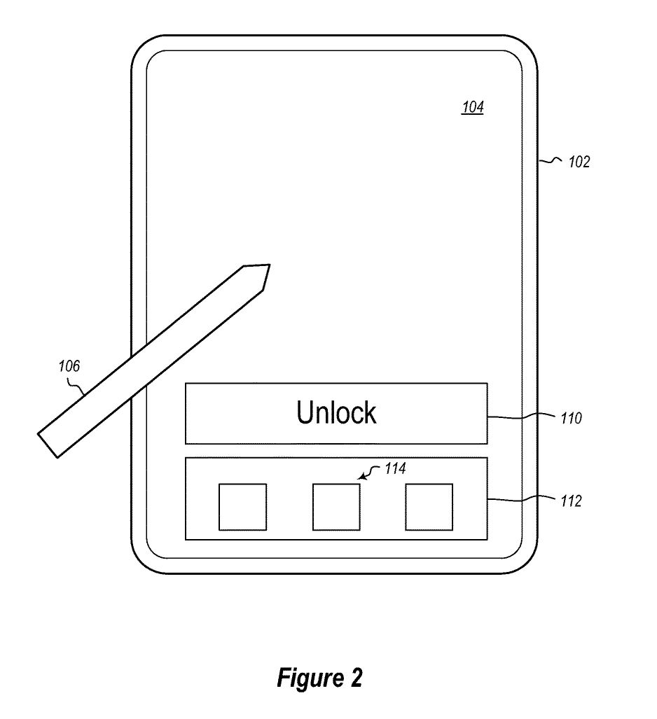

In some embodiments a variety of different casual digital ink experiences may be available to a user. Additionally, a variety of different casual digital ink experiences may be persisted such that a user can select from among a number of different casual digital ink experiences to begin fresh interaction or to resume a previous interaction on the personal computing device 102. An example of this is illustrated in FIG. 2. FIG. 2 illustrates the personal computing device 102. The active pen 106 can interact with the screen 104 of the personal computing device 102. When the active pen 106 interacts with the screen 104 of the personal computing device 102, in the illustrated example, an unlock interface element 110 is displayed along with a casual digital ink experience interface window 112. If the user possesses appropriate credentials, the user can use the unlock interface element 110 to unlock the personal computing device 102 and can access all of the applications and services on the personal computing device 102. However, if the user does not possess the appropriate credentials to unlock the personal computing device 102, the user can nonetheless select a casual digital ink experience from the casual digital ink experience interface window 112.

As noted above, various alternatives may exist for the casual digital ink experiences that can be selected from the casual digital ink experience interface window 112. For example, in some embodiments, the user may be able to select from a number of fresh casual digital ink experiences. For example, the user may be able to select between a drawing program, a coloring program, a tick-tack-toe experience, etc. This may be such that a user may be able to interact in a fresh way such that no previous interactions have been persisted for the casual digital ink experience selected by the user.

Alternatively, the user may be able to select from a group of casual digital ink experiences where previous interaction has occurred. For example, the casual digital ink experience interface window 112 may display to a user a set 114 of digital ink experiences that have persisted user input such that a user will resume the casual digital ink experience where a previous user (or the user themselves) has previously interacted with the casual digital ink experience. While the example illustrated in FIG. 2 illustrates a single casual digital ink experience interface window 112, it should be appreciated that the number of different windows may be displayed. For example, in some embodiments, one casual digital ink experience interface window may be displayed which includes casual digital ink experiences with persisted user input, while a different casual digital ink experience interface window is provided to allow user to select a new fresh casual digital ink experience.

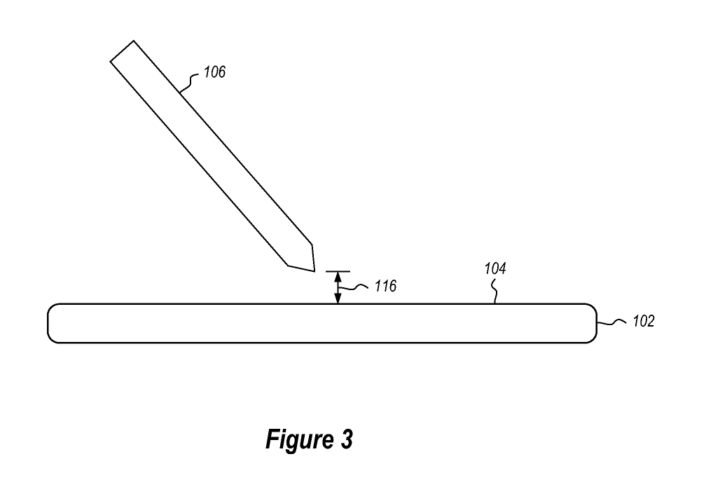

In some embodiments, detecting the active pen 106 interacting with the screen 104 of the personal computing device may include detecting that the active pen 106 is within a given proximity to the screen 104 of the personal computing device 102. For example, with reference to FIG. 3, the active pen 106 is illustrated at a distance 116 from the screen 104 of the personal computing device 102. For example, in some embodiments, when the active pen 106 is within the 5 mm of the screen 104 of a personal computing device 102, and the lock screen of the personal computing device 102 has locked the personal computing device 102, then the personal computing device 102 will launch a casual digital ink experience based on the active pen 106 being within a predetermined distance 116 of 5 mm (or some other predetermined distance).

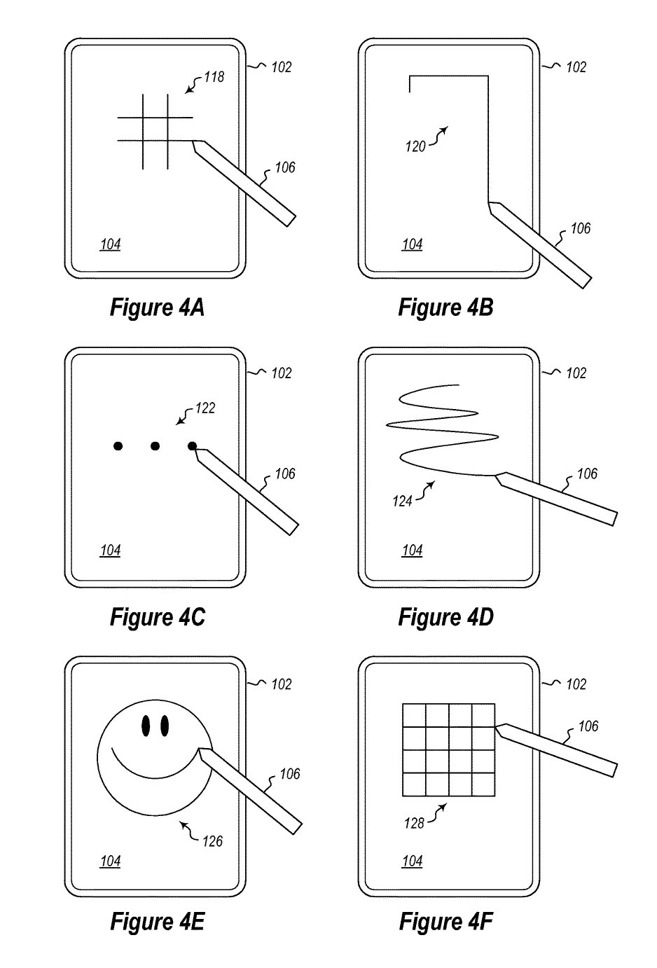

In some embodiments, detecting and active pen interaction with the screen of the computing system may include detecting a particular form being drawn on the screen, and as a result launching a particular corresponding casual digital ink experience. Examples of this are illustrated in FIG. 4A for a through FIG. 4F.

For example, as illustrated in FIG. 4A, a user uses the active pen 106 to draw a tick-tack-toe form 118 on the screen 104 of the personal computing device 102. This would cause the personal computing device to launch a digital version of a tick-tack-toe interaction complete with digital scoring and other digital features of such an interaction.

Alternatively, as illustrated in FIG. 4B, a user may use the active pen 106 to draw a 7 form 120 on the screen 104 of the personal computing device 102. This would cause the personal computing device to launch a hangman interaction complete with digital scoring, random or pseudo random selection of one or more words to guess, etc.

Alternatively or additionally as illustrated in FIG. 4C, a user may use the active pen 106 to draw a form 122 that includes a series of dots. This would cause the personal computing device 102 to launch a dot based interaction, such as dot-to-dot puzzle or interactive dot interaction.

Alternatively or additionally as illustrated in FIG. 4D, a user may use the active pen 106 to draw a scribble form 124 on the screen 104 of the personal computing device 102. In this example, this could launch an adult (or other) coloring interaction as a casual digital ink experience allowing a user to color images provided by the casual digital ink experience by providing images for the user to color and various digital drawing tools (e.g., pens, paints, erasers, etc.) for the user to use when coloring the images.

Alternatively or additionally, as illustrated in FIG. 4E, a user may use the active pen 106 to draw a simple image form 126 on the screen 104. This would cause the personal computing device 102 launch a drawing program as a casual digital ink experience allowing the user to have available various drawing tools to draw images in the casual digital ink experience.

Alternatively or additionally as illustrated in FIG. 4F, a user may use the active pen 106 to draw a create a grid form 128. This will cause the personal computing device 102 to launch a Sudoku interaction, crossword puzzle, or other grid type interaction.

These examples illustrated in FIG. 4A through FIG. 4F are merely illustrative, and those of skill in the art could readily identify other interactions within the scope of embodiments of the invention.

While generally embodiments may include functionality to persist user input into a casual digital ink experience from user session to user session, some embodiments may include functionality to facilitate a user restoring a given casual digital ink experience to its default state. Thus for example, if the casual digital ink experience 108 is a crossword puzzle, a user may wish to interact with the crossword puzzle and then, when finished restore the crossword puzzle to its original state with no digital ink in the crossword puzzle preventing the user interaction with the crossword puzzle from being detected by another user. For example when another user picks up the personal computing device 102. Various different alternatives may exist for erasing user input and restoring the casual digital ink experience to its default state.

For example, in some embodiments a user may shake the personal computing device 102. Accelerometers and other motion detection hardware within the personal computing device 102 can detect the shaking action, and as a result cause a currently active casual digital ink experience 108 to reset to its default state. Thus for example, a user shaking the personal computing device 102 according to some predetermined parameters such as amount of motion, strength of shaking, period of shaking, etc., will cause all digital ink to be removed such that the experience is restored to its default state.

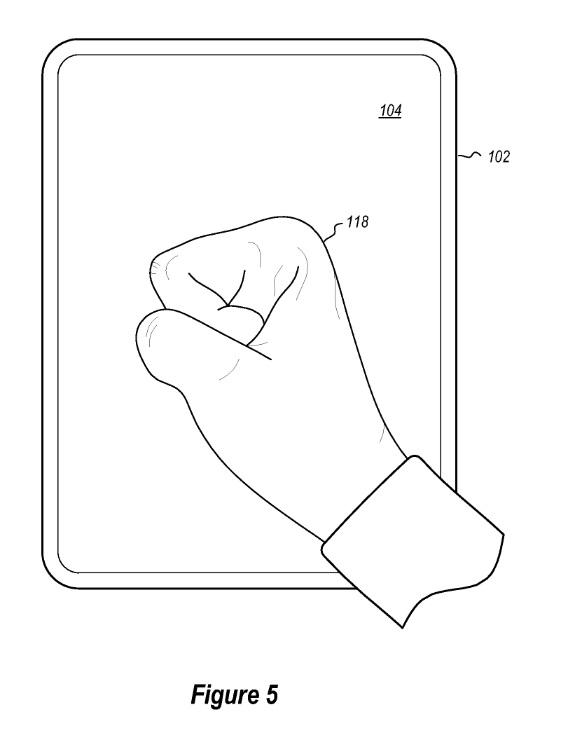

Referring now to FIG. 5, an alternative example is illustrated. In this example, a user may use a large surface area interaction with the screen 104 of the personal computing device 102 to cause a casual digital ink experience to be restored to its default state. In the example illustrated in FIG. 5, a user first 118 is illustrated. The user wipes the screen 104 by rubbing their first 118 on the screen 104 of the personal computing device 102. This rubbing motion, using something with a sufficiently large surface area, will cause the casual digital ink experience 108 to reset to its default state. Thus, while a first is illustrated here, other embodiments may allow for the use of a palm, multiple fingers, arm, or other appendage or tool with a sufficiently large surface area being rubbed on the screen 104.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

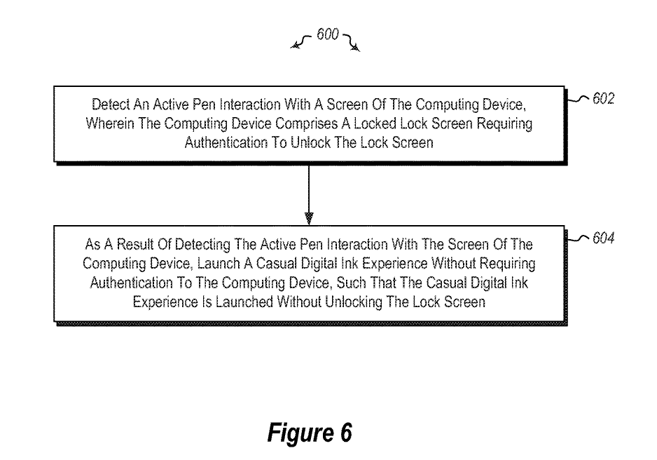

Referring now to FIG. 6, a method 600 is illustrated. The method 600 may be practiced on an active pen capable computing device. The method includes acts for providing casual digital ink experiences. The method includes detecting an active pen interaction with a screen of the computing device (act 602). The computing device comprises a locked lock screen requiring authentication to unlock the lock screen. For example as illustrated in the examples above, the active pen 106 may interact with the screen 104 of the personal computing device 102. Additionally, FIG. 2 illustrates an unlocked interface element 110 that can be used to unlock the personal computing device 102.

The method 600 further includes, as a result of detecting the active pen interaction with the screen of the computing device, launching a casual digital ink experience without requiring authentication to the computing device, such that the casual digital ink experience is launched without unlocking the lock screen (act 604). For example, as illustrated in FIG. 1 above, the casual digital ink experience 108 may be launched on the personal computing device 102 when the active pen 106 interacts with the screen 104 of the personal computing device 102.

The method 600 may be practiced where the active pen interaction comprises the active pen being within a predetermined proximity to the screen. An example of this is illustrated in FIG. 3 which shows the active pen 106 within a predetermined distance 116 to the screen 104 of the personal computing device 102.

In some embodiments, when the active pen is detected to be within a predetermined proximity to the screen, the method may further include displaying a selection of previously started casual interactions. For example, as illustrated in FIG. 2, casual digital ink experience interface window 112 may be displayed showing a set 114 of casual digital ink experiences that can be selected by a user.

In some embodiments, when the active pen is detected to be within a predetermined proximity to the screen, the method may further include displaying a selection of new casual interactions. Again, as illustrated in FIG. 2, the set 114 of digital ink experiences that can be selected by a user may be a set of new casual digital ink experiences that are selectable by a user.

The method 600 may be practiced where the active pen interaction comprises the active pen drawing a form corresponding to a casual digital ink experience. For example, as illustrated in FIG. 4A through FIG. 4F, various different forms may be detected where the active pen 106 is used to draw a form on the screen 104 the personal computing device 102.

The method 600 may further include receiving user input indicating that content generated in the casual digital ink experience should be shared For example, FIG. 1 illustrates a share element 130 that can be selected by a user to allow the user to share content generated in the casual digital ink experience 108 with others. For example, the content may be shared by email, social media, etc. Because the user is not authenticated to the digital device 102, the user may need to authenticate within the casual digital ink experience to allow sharing to occur. Alternatively, embodiments may be able to share in a non-authenticated fashion. For example, the casual digital ink experience may include an email box user interface element that a user can enter an email address into. The service associated with the casual digital ink experience can then send digital ink content to the e-mail address specified in the email box user interface element.

In some embodiments, when a user is required to authenticate to the digital ink experience to share content, the user may need to re-authenticate each time the user wishes to share the content as the digital ink experience may not persist such authentication information. In particular, the digital ink experience may authenticate, send content, and then immediately forget authentication information. Thus, and each time a user wishes to share digital ink experience content, the user will need to re-authenticate to the digital ink experience.

Some embodiments may be implemented where there is no choice as to whether not content is persisted from session to session. Rather, the content is either always persisted or always discarded after a session. However, other embodiments may allow user to determine whether digital ink experience content is persisted from session to session or not.

The method 600 may further include receiving user input indicating that content generated in the casual digital ink experience should be erased such that the causal digital ink experience is rest to a default state. For example, this may be performed by shaking the device. Alternatively or additionally, this may be performed by performing some kind of wiping motion such as in the examples illustrated above, such as where a first is used to wipe the screen of the digital device.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
one or more processors; and
one or more computer-readable media having stored thereon instructions that are executable by the one or more processors to configure the computer system to provide casual digital ink experiences, including instructions that are executable to configure the computer system to perform at least the following:
detect an active pen interaction with a screen of the computing device, wherein the computing device comprises a locked lock screen requiring authentication to unlock the lock screen;
as a result of detecting the active pen interaction with the screen of the computing device, launch a casual digital ink experience without requiring authentication to the computing device, such that the casual digital ink experience is launched without unlocking the lock screen.

2. The system of claim 1, wherein the active pen interaction comprises the active pen being within a predetermined proximity to the screen.

3. The system of claim 2 wherein one or more computer-readable media further have stored thereon instructions that are executable by the one or more processors to configure the computer system to, when the active pen is detected to be within a predetermined proximity to the screen, then display a selection of previously started casual interactions.

4. The system of claim 2 wherein one or more computer-readable media further have stored thereon instructions that are executable by the one or more processors to configure the computer system to, when the active pen is detected to be within a predetermined proximity to the screen, then display a selection of new casual interactions.

5. The system of claim 1, wherein the active pen interaction comprises the active pen drawing a form corresponding to a casual digital ink experience.

6. The system of claim 1, wherein one or more computer-readable media further have stored thereon instructions that are executable by the one or more processors to configure the computer system to receive user input indicating that content generated in the casual digital ink experience should be shared.

7. The system of claim 1, wherein one or more computer-readable media further have stored thereon instructions that are executable by the one or more processors to configure the computer system to receive user input indicating that content generated in the casual digital ink experience should be erased such that the causal digital ink experience is rest to a default state.

8. On an active pen capable computing device, a method of providing casual digital ink experiences, the method comprising:
detecting an active pen interaction with a screen of the computing device, wherein the computing device comprises a locked lock screen requiring authentication to unlock the lock screen;
as a result of detecting the active pen interaction with the screen of the computing device, launching a casual digital ink experience without requiring authentication to the computing device, such that the casual digital ink experience is launched without unlocking the lock screen.

9. The method of claim 8, wherein the active pen interaction comprises the active pen being within a predetermined proximity to the screen.

10. The method of claim 9 further comprising, when the active pen is detected to be within a predetermined proximity to the screen, then displaying a selection of previously started casual interactions.

11. The method of claim 9 further comprising, when the active pen is detected to be within a predetermined proximity to the screen, then displaying a selection of new casual interactions.

12. The method of claim 8, wherein the active pen interaction comprises the active pen drawing a form corresponding to a casual digital ink experience.

13. The method of claim 8, further comprising receiving user input indicating that content generated in the casual digital ink experience should be shared.

14. The method of claim 13, further comprising:
receiving user input authenticating to an email account;
sharing the content generated in the casual digital ink experience through the email account; and
within a predetermined time after sharing the content, forgetting authentication information for the email account.

15. The method of claim 13, further comprising sharing the content in a non-authenticated fashion.

16. The method of claim 8, further comprising receiving user input indicating that content generated in the casual digital ink experience should be erased such that the causal digital ink experience is rest to a default state.

17. The method of claim 16, wherein the user input comprises the user shaking the computing device.

18. The method of claim 16, wherein the user input comprises the user rubbing the screen of the device with an appendage or tool with a sufficiently large surface area.

19. A computing device comprising:
a screen;
an active pen configured to interact with the screen;
wherein the system is configured to detect interaction of the active pen with the screen of the computing device, wherein the computing device comprises a locked lock screen requiring authentication to unlock the lock screen;
wherein the system is configured to, as a result of detecting the active pen interaction with the screen of the computing device, launch a casual digital ink experience using the screen without requiring authentication to the computing device, such that the casual digital ink experience is launched without unlocking the lock screen.

20. The system of claim 1, wherein the active pen interaction comprises the active pen drawing a form corresponding to a casual digital ink experience.
